(19) United States
(12) Patent Application Publication
(10) Pub. No.: US 2008/0079313 A1
(43) Pub. Date: Apr. 3, 2008

(54) METHOD AND SYSTEM FOR PREVENTING ACCESS TO A BUILDING AND VEHICLE

(75) Inventor: CARL ELLINGSWORTH, Ottawa (CA)

Correspondence Address: OGILVY RENAULT LLP, 1981 MCGILL COLLEGE AVENUE, SUITE 1600, MONTREAL, QC, H3A2Y3, CA

(73) Assignee: 2TIS TECHNOLOGIES INC., Vancouver (CA)

(21) Appl. No.: 11/857,079

(22) Filed: Sep. 18, 2007

Related U.S. Application Data
(63) Continuation-in-part of application No. 10/974,848, filed on Oct. 28, 2004, now Pat. No. 7,285,872.
Application No. 10/974,848 is a continuation-in-part of application No. 09/832,979, filed on Apr. 12, 2001, now Pat. No. 6,819,009.
(60) Provisional application No. 60/196,301, filed on Apr. 12, 2000.

(51) Int. Cl. B60R 25/00

(52) U.S. Cl. 307/10.3; 340/5.2

(57) ABSTRACT

A system for preventing unauthorised use of a vehicle having an engine housing and a device for enabling starting of the engine amongst other ancillary features is disclosed. The system provides a wireless smart card reader and a smart card which, may be a multi-function smart card for use with the reader. A circuit is provided in the system which disables operation of the vehicle. The circuit is integrated for electrical disablement by the smart card reader. The circuit includes an interrupt circuit connected to the device for enabling starting of the vehicle. The circuit is primarily directed to selective interruption. The circuit is positioned directly within the engine housing in order to prevent tampering or any other activity which would render the circuit inoperative or bypassed. As a further feature, the system, provide access to a building and the building can communicate with the wireless card reader associated with a vehicle to effect operation of the vehicle. A method of use accompanies the apparatus.

This application is a continuation-in-part of U.S. patent application Ser. No. 10/974,848 filed Oct. 28, 2004, which is a continuation-in-part of U.S. patent application Ser. No. 09/832,979, filed Apr. 12, 2001, which claims the benefit of U.S. Patent Application Ser. No. 60/196,301, filed Apr. 12, 2000.

### FIELD OF THE INVENTION

The present invention relates to a system and method for preventing unauthorized use and/or access to a building and vehicle and more particularly, the present invention relates to a device that provides owners and authorized users varying degrees of control over their vehicle including its theft prevention, particularly for constantly running vehicles such as a fire truck.

### BACKGROUND OF THE INVENTION

Generally speaking, the theft of vehicles such as snowmobiles, ATVs, watercrafts, motorcycles and other vehicles having a magneto/stator present in the motor system, including most non jet propulsion aircraft, is fairly straightforward, much to the demise of the owners of such vehicles. This is also a problem for automobiles despite the fact that they do not include a magneto or stator.

The simplicity in, for example, starting the motors of these vehicles is realized by the arrangements used to link the ignition system to the ignition generator coil. In snowmobiles, for example, the block connectors electrically connect the ignition switch, kill switch and power accessories to the ignition switch. These elements are all exposed outwardly of the motor. To the skilled thief, since these elements are readily accessible, bypass is simple and can typically be achieved in seconds. The result is that the vehicle can be easily started and driven away with ease and with a minimum of effort.

In an attempt to speak to the escalation in theft of these vehicles, many devices have been proposed in the art which attempt to provide the user/owner with a greater degree of security. The arrangements known incorporate alarms, keylock systems, manual circuit interrupts inter alia. These devices, although somewhat useful, are all limited by the same vulnerability, namely the fact that they are external systems which are accessible by a thief and therefore are easily disabled by bypass or “hot wiring”.

In the case of snowmobiles, track locks have been proposed. These devices are simply not pragmatic; the user is confined to carrying these bulky awkward items on the snowmobile which requires storage space. This space is often at a premium in view of the size of the snowmobile.

A current manufacturer has offered a digital system (for selected models) and even though its method has a level of effectiveness, it is still vulnerable by its external application. Accordingly, the owner of earlier model vehicles is not helped by the new technology.

Other systems for preventing theft of watercraft include markings on the craft itself or special indications on the hull identification plate. These attempts at preventing theft can be easily circumvented by simply removing and replacing the plates or altering the information thereon.

In terms of automobiles, steering wheel arrangements such as the Club™ are typically employed. These devices are somewhat useful, but are easily removable by determined thieves.

Immobilizers are also used in automobiles for theft prevention, but are limited by their external disposition.

Perhaps one of the most difficult situations relates to constantly running vehicles or emergency vehicles. These are highly vulnerable to theft, since the driver, once the vehicle is parked, for example, is preoccupied and therefore not cognizant of unscrupulous activity. These conditions make theft trivial to complete. In situations as noted above, it would be useful if the vehicle could receive information updates concerning a patient or situation available to the driver (user) upon his return to the vehicle. Further, it would be advantageous, in the fire fighting scenario, where the firemen could access an adjacent building with a smart card without having to damage the building or risk loss of the fire truck through theft. The present invention seeks to amalgamate present needs for security with available technology in a previously uncombined and novel manner.

In view of the fact that the vehicles are expensive, a more sophisticated method and apparatus is required which is not external of the motor or engine and which does not employ interceptable digital streams.

The present invention addresses this need and thus one object of one embodiment of the present invention is to provide a control device mounted internally of the engine. This renders control of operation of the vehicle inaccessible to tampering.

### SUMMARY OF THE INVENTION

One object of the present invention is to provide an improved apparatus and method for preventing unauthorized use of and ultimately the control of a vehicle.

A further object of the present invention is to provide a system for preventing unauthorized use of a vehicle having an engine housing and means for enabling starting of said engine, comprising, in combination a wireless smart card reader, a smart card for reading by said smart card reader, a circuit for disabling operation of said vehicle operatively connected to said smart card reader, comprising an interrupt circuit electronically connected to said means for enabling starting of said vehicle, said circuit for selectively interrupting said means for enabling starting of said vehicle, said circuit being mounted directly within said engine housing, switch means mounted within said engine housing and connected to said circuit for allowing interruption to said means for enabling starting of said vehicle, said switch means responsive to communication with said wireless smart card reader and battery connecting means for connecting said wireless smart card reader to the battery of a vehicle engine responsive to signals from said wireless smart card reader.

As a particular convenience, the switch means may be selected from any suitable switching devices, such as mechanical, electrical, electro-mechanical, electronic (digital) arrangements. The important feature is that the circuit (supra) is positioned within the housing as opposed to externally; this latter arrangement is what limited the effectiveness of the prior art.

Another object of one embodiment of the present invention is to provide a smart card based security system for preventing unauthorized use of a vehicle and unauthorized communication with a building, said system, comprising a vehicle wireless smart card reader connected within said vehicle, a building wireless smart card reader for permitting communication with said building, a smart card for communication with the readers, a circuit for disabling operation of said vehicle operatively connected to said smart card reader, comprising an interrupt circuit electronically connected to said means for enabling starting of said vehicle, said circuit for selectively interrupting said means for enabling starting of said vehicle, said circuit being mounted directly within said engine housing switch means mounted within said engine housing and connected to said circuit for allowing interruption to said means for enabling starting of said vehicle, said switch means responsive to communication with at least one of said wireless smart card reader and said building wireless smart card reader, and battery connecting means for connecting said wireless smart card reader to the battery of a vehicle engine responsive to signals from said wireless smart card reader, whereby said system is capable of data conveyance between said vehicle and said building.

The mounting location for the circuit is conveniently anywhere within the housing with a suitable connection to the ignition generator coil. As an example of a useful position, the circuit may be positioned between the stator and magneto.

A still further object of one embodiment of the present invention is to provide a method for preventing unauthorized use of a vehicle having an engine housing and means for enabling starting of said engine, comprising providing said vehicle with a wireless smart card reader, providing a smart card for reading by said smart card reader, providing a circuit for disabling operation of said vehicle operatively connected to said smart card reader, comprising, an interrupt circuit electronically connected to said means for enabling starting of said vehicle, said circuit for selectively interrupting said means for enabling starting of said vehicle, said circuit being mounted directly within said engine housing, switch means mounted within said engine housing and connected to said circuit for allowing interruption to said means for enabling starting of said vehicle, said switch means responsive to communication with said wireless smart card reader; and battery connecting means for connecting said wireless smart card reader to the battery of a vehicle engine responsive to signals from said wireless smart card reader, and contacting said smart card in proximity with said switch means to effect an enabled start of said vehicle.

The transceiver arrangement facilitates communication between the vehicle and other extraneous communication devices such as satellite systems, computers, web enabled cellular phones, GPS, personal digital assistants (PDA) or any other suitable device or combination of devices useful for communication.

The transceiver system can be used to control operation of the ignition generator, engine rpm, air/fuel mixture inter alia.

The provision for GPS capacity allows for tracking of the vehicle in the event it is stolen.

As a further object of one embodiment of the present invention, there is provided a method for preventing unauthorized use of a vehicle and unauthorized communication with a building based on a smart card platform security system, comprising providing a vehicle wireless smart card reader connected within said vehicle, providing a building wireless smart card reader for permitting communication with said building, a smart card for communication with the readers, providing a circuit for disabling operation of said vehicle operatively connected to said smart card reader, comprising an interrupt circuit electronically connected to said means for enabling starting of said vehicle, said circuit for selectively interrupting said means for enabling starting of said vehicle, said circuit being mounted directly within said engine housing, switch means mounted within said engine housing and connected to said circuit for allowing interruption to said means for enabling starting of said vehicle, said switch means responsive to communication with at least one of said wireless smart card reader and said building wireless smart card reader, and battery connecting means for connecting said wireless smart card reader to the battery of a vehicle engine responsive to signals from said wireless smart card reader, whereby said data conveyance between a vehicle point and a building point, a user point and said vehicle point, said user point and said building point and said vehicle point and said building point is effected wirelessly through said readers and said card to prevent illegitimate activity through the points.

A still further of object of one embodiment of the present invention is to provide a method for controlling vehicle function, operation and unauthorized use of said vehicle having an engine and block therefor, sensors for effecting engine activation and other functions, a power source, ignition coils, and means for establishing communication between said sensor and said coils, said method comprising the steps of providing switch means for and augmenting communication to and/or from said sensors for altering function of said sensors, providing wireless transceiver means connected to said switch means for receiving electromagnetic signals from a signal service provider and transmitting electromagnetic signals to said signal service provider, said switch means being actuable by said transceiver means, positioning said switch means and said transceiver means between at least one sensor of said sensors and said means for establishing communication between said sensors and said coils, mounting said switch means and said transceiver means to said at least one sensor, and activating said switch means by said transceiver means for communicating with said sensors for altering engine activation and other functions.

The means for establishing electrical communication between the sensors and coils is known in the art as an ECM motherboard. In current arrangements, the ECM motherboard in automobiles is externally mounted of the engine and thus is vulnerable to tampering. If removed and replaced with a similar component not equipped with a theft deterrent (immobilizer) auto theft is easily achieved.

By providing the switch arrangement and mounting location, the presence of an immobilized ECM motherboard is of no consequence; the arrangement discussed supra interrupts power to the sensors leading to the ECM motherboard and further is mounted at least partially within the engine block to avoid tampering, bypass or expeditious removal. The ECM may also be mounted internally.

As a particularly attractive advantage, the switch means may be integrally mounted to the sensor or a plurality of sensors. By providing several such switches, security for preventing unauthorized access may be augmented.

Further still, the smart card used in the present invention may be remotely updated with further information at any time. The information may be specific to one user to provide limited access to a building or other property as an example. Obviously, the system can operate on a network to alter many cards at one time. Broadly, examples of smart cards are known; the HID Company presently provides such cards. Although this is the case, the unification of a vehicle disabling circuit and building access provision has not been previously proposed.

It will be readily apparent to those skilled that the vehicles having stator/magneto arrangements could easily be adopted to the circuit mentioned above where the stator/magneto is removed in future modifications of such vehicles.

Having thus described the invention, reference will now be made to the accompanying drawings illustrating preferred embodiments.

### BRIEF DESCRIPTION OF THE DRAWINGS

FIG. 1 is a perspective view of a typical engine of the vehicles set forth herein;

FIG. 2 is a view similar to FIG. 1 with the cover removed from the stator housing;

FIG. 3 is a schematic diagram of the wiring of a typical snowmobile;

FIG. 4 is a view similar to FIG. 2 with the arrangement according to one embodiment installed;

FIG. 5 is an abbreviated schematic diagram illustrating the positioning of the elements according to one embodiment of the present invention.

FIG. 6 is a schematic diagram of the starting circuit for an automobile with the switch;

FIG. 7 is a schematic illustration of a vehicle and positioning of various sensors; and

FIG. 8 is a schematic diagram of the switch arrangement in relation to the sensor(s) and ECM motherboard.

FIG. 9 is a schematic illustration of a vehicle and positioning of sensors.

FIG. 10 is a schematic diagram of the switch arrangement in relation to the sensors and ECM motherboard.

FIG. 11 is a schematic illustration of another embodiment.

FIG. 12 is a schematic illustration of another embodiment.

FIG. 13 is a schematic illustration of another embodiment.

FIG. 14 is a schematic illustration of an embodiment of the present invention incorporating smart card technology; and

FIG. 15 is a further embodiment of FIG. 14.

### DETAILED DESCRIPTION OF THE PREFERRED EMBODIMENTS

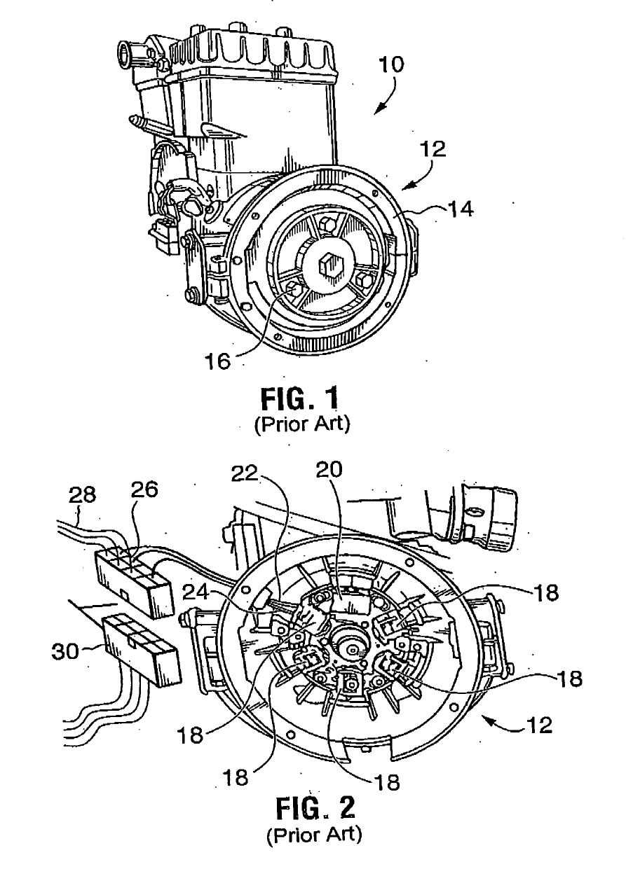

Referring now to the drawings and particularly FIG. 1, numeral 10 generally references the engine. There is provided a housing 12 for housing the magneto and stator. A cover 14 is fixed by fasteners 16 to provide a sealed stator/magneto housing. As is generally known, specialized tools and skill are required to remove the cover 14 and eventually gain access to the interior of the housing 12.

FIG. 2 illustrates the interior of the housing 12 where there are mounted several coils 18, shown in the example as a quantity of five. A main coil or ignition generator coil 20 is also provided and is integral in starting the engine. It is known that such coils generally operate on the principle of sensors. Coil 20 has two leads 22 and 24 which terminate at a block connector 26. Block connector 26 also includes leads, generally referenced by numeral 28, leading to the CDI box (not shown). A mating block connector 30 connects to block connector 26 and the former provides leads to the ignition switch, kill switch and power accessories (none of which is shown) of the vehicle (not shown).

The arrangement is generally well known in the art. Unfortunately, it is also well known that by simply disconnecting the block connectors 26 and 30, all security systems typically associated with the vehicle are disabled while a signal is still capable of being supplied to the CDI box from the ignition generator coil 20. Accordingly, the vehicle will start in this condition.

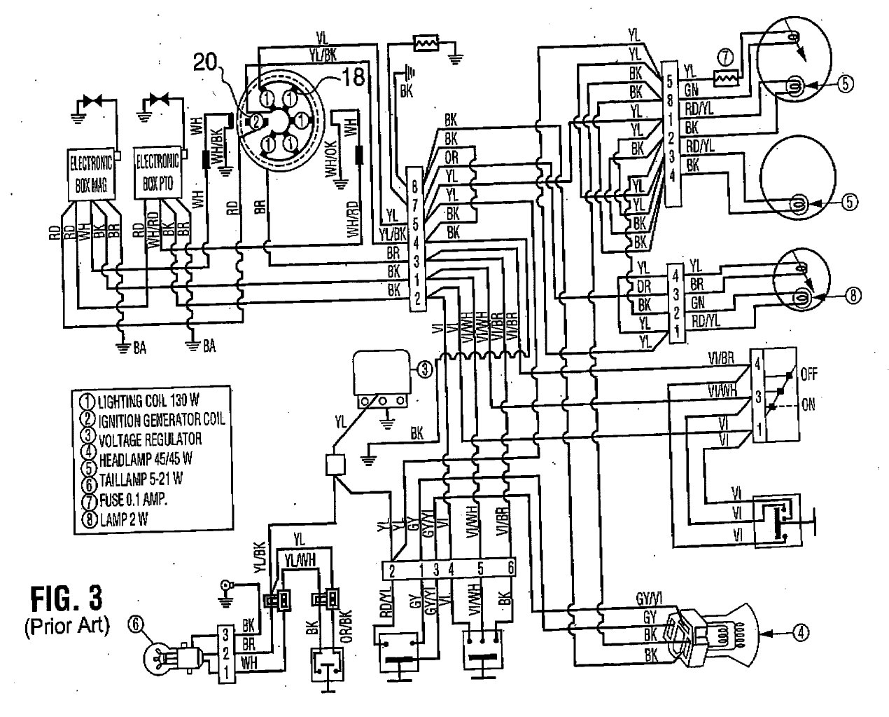

FIG. 3 illustrates a typical schematic diagram for a conventional snowmobile, although the diagram is applicable to typical magneto/stator motors. As the diagram illustrates, the disposition of the ignition generator coil 20 in the circuit facilitates easy starting of the engine when the block connectors 26 and 30 are disconnected.

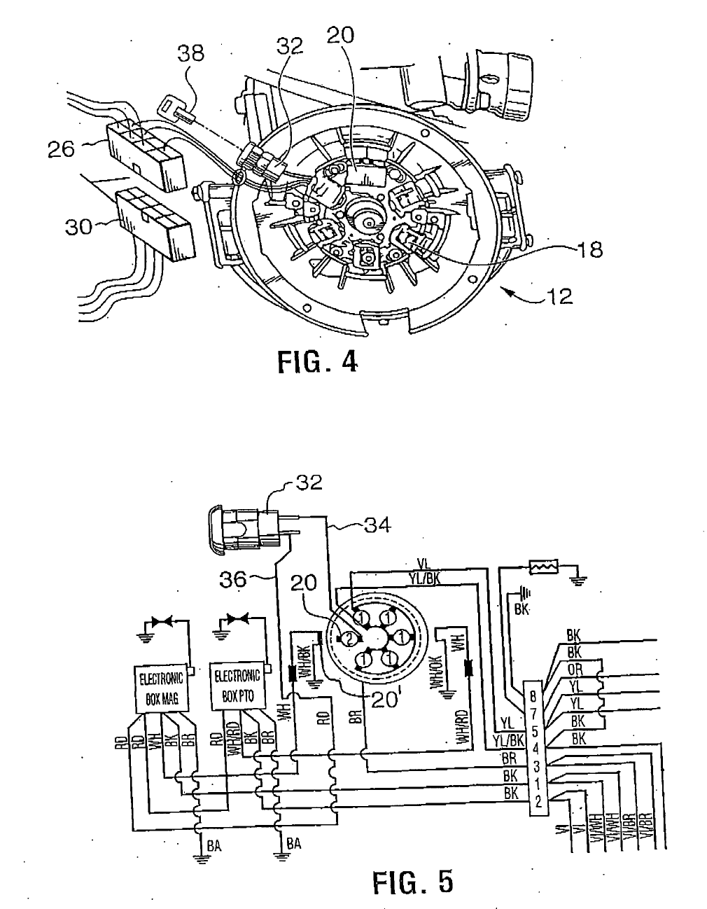

FIG. 4 illustrates an example of the invention as positioned within the housing 12. A switch 32 is disposed in housing 12 and in this case is an electrical/mechanical switch. FIG. 5 illustrates a truncated schematic of the circuit of FIG. 4 showing the positioning of the switch 32 and its relationship to ignition generator coil 20. As illustrated, the switch 32 includes leads 34 and 36, with lead 34 being connected to ignition generator coil 20 and lead 36 extending to other electrical connections related to starting the vehicle. By connection to ignition generator coil 20, the circuit is interrupted in the OFF position and is unaffected by disconnection of block connectors 26 and 30. Accordingly, the user, in order to start the vehicle must initially actuate the switch 32 into the ON position with, for example, a key 38 which, in turn, will re-enable the ignition generator coil 20. Once this is done, normal procedures may be performed to start the vehicle.

In the embodiment of FIG. 5, a switch is mounted in the housing 12 adjacent the ignition generator coil 20. Trigger coils are reverenced by numeral 20′. This is not essential. In the situation where the switch system comprises a remotely controllable arrangement, the switch may be replaced by a receiver (not shown) well known in the art. In these devices an antenna can be positioned in any convenient location provided it can communicate with a transmitter (not shown). It will be appreciated to those skilled in the art that any suitable switch capable of selectively interrupting the ignition generator coil circuit may be used.

Advantageously, by positioning the circuit interrupt portion of the switch within the housing, tampering or bypass is difficult, tedious and would more than likely damage the vehicle if a thief attempted any tampering. Further, if the switch mechanism is damaged, broken or removed, the vehicle cannot be made to start unless original wiring is restored. Cover 14 is removed and the switch 32 removed from the vehicle. This is obviously time consuming and cannot be performed with any degree of stealth.

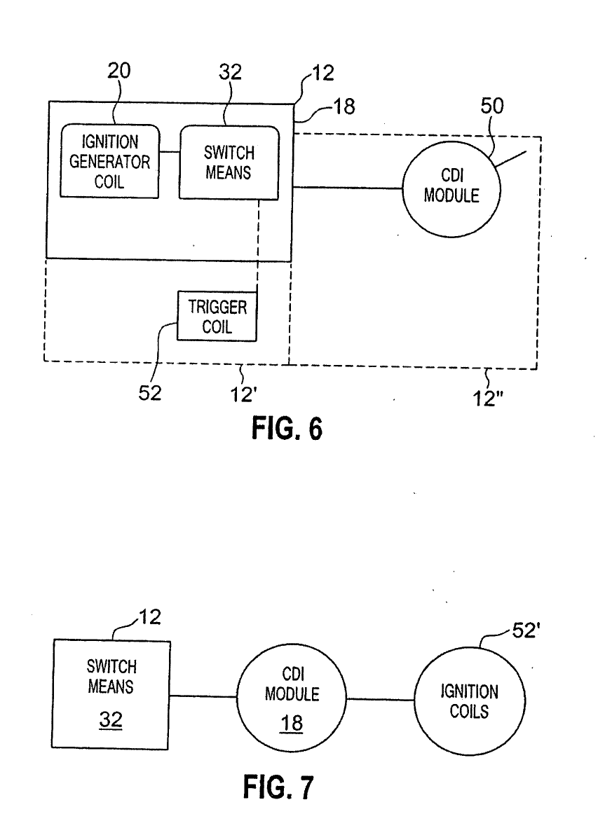

FIG. 6 illustrates a further embodiment of the overall concept of the invention. In this embodiment, the engine housing 12 is shown the ignition generator coil 20 connected to the switch means 32 and the circuit positioned within housing 12. As illustrated, this circuit is electrically connected to a CDI box, referenced in this figure by number 18. The CDI module 18 is, in turn, electrically connected to the additional coils as well as a power supply (not shown) as is well known. As a further variation of FIG. 6, the dashed line represented by numeral 12′ constitutes the engine housing 12, but accommodates a trigger coil 52, which trigger coil 52 communicates electrically with switch means 32 and subsequently to CDI module 18. This is a variation where the trigger coil 52, switch means 32 and CDI module 18 are electrically connected for interruption. This provides an alternative to the ignition generator coil 20, switch means 32 and CDI module 18 combination.

As still a further variant, the engine housing represented by the extended chain line 12″ may also include the CDI module 50 such that the CDI module 50, switch 32 and ignition generator coil 20 as well as trigger coil 52 are all positioned within the engine housing.

FIG. 7 illustrates a further variation where the electrical communication between switch means 32 and ignition coils, referenced as 52′, is interrupted by CDI 18.

The point in the further variations is to demonstrate the fact that the switch 32 is positioned within the housing and is in one manner or another connected to an essential element required for operation of the engine (not shown). By this provision, theft of the vehicle incorporating the variants outlined in FIG. 6 is substantially averted, since no parts are available outside of the engine compartment for easy removal and or exchange in order to steal the vehicle.

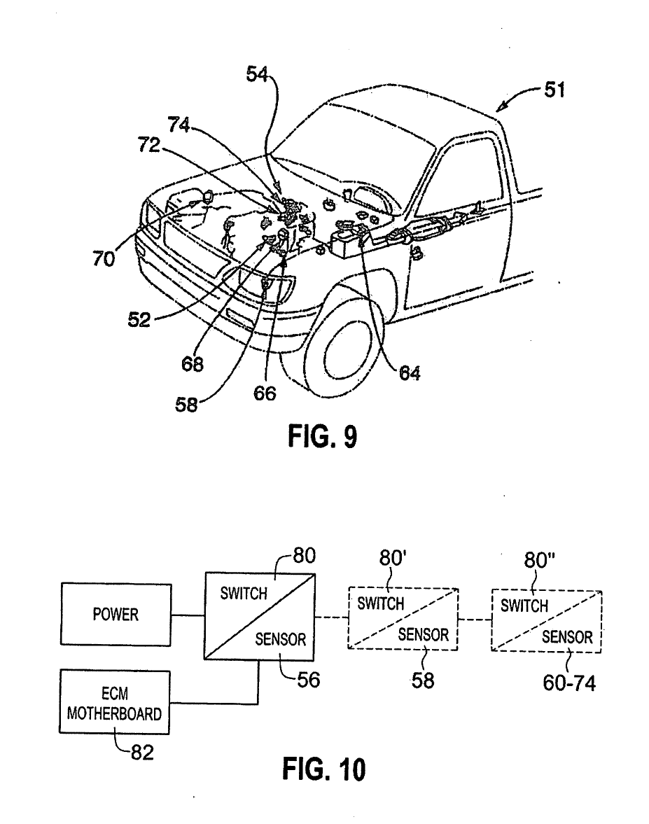

In FIG. 9, a vehicle 51 is shown and includes an engine and an engine block, broadly denoted by numeral 54. As is known, a number of sensors are required to carry out various functions with respect to the operation of the vehicle. In the example, numeral 56 represents a camshaft position sensor, numeral 58 represents a crankshaft position sensor and numerals 56 through 74 represent other sensors, amplifiers, inter alia.

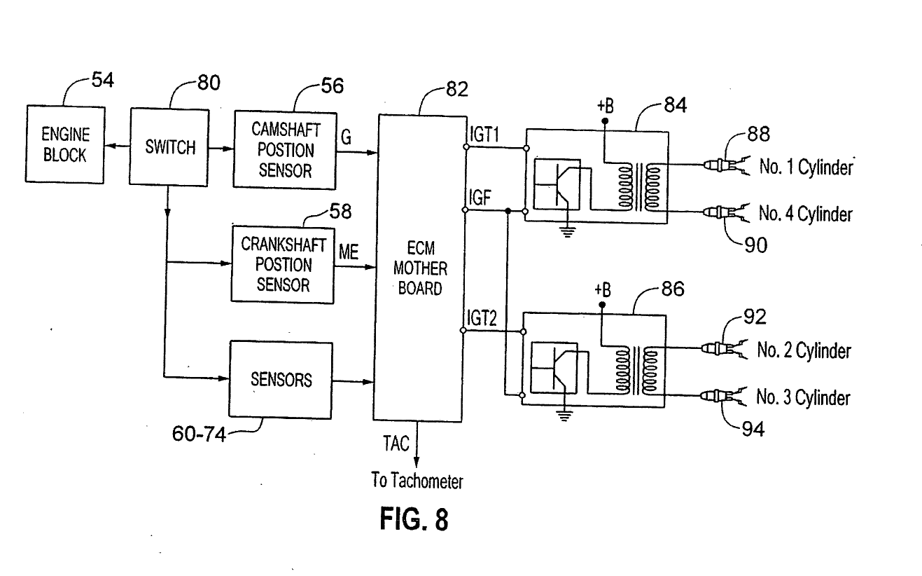

As is illustrated in FIG. 8, disposed between engine 54 and sensors 56 through 74 is a switch 80. The sensors 56 through 74 are in electrical communication with an ECM motherboard 82 which is responsible for numerous functions, the most important of which for purposes of this discussion is communication between the sensors and ignition coils 84 and 86. As is known, coils 84 and 86 each communicate with cylinders 88, 90, 92, and 94, respectively.

By providing power and/or signal interruption via switch 80 to the sensors 56 through 74, it is inconsequential as to whether the ECM motherboard 82 is equipped with anti-theft provisions such as an immobilizer (not shown). This is a significant advantage since the sensors are effected by the switch 80 as opposed to the ECM motherboard 82. By effecting the sensors 56 through 74, the ECM motherboard 82 is also effected. This is a more effective system since it does not matter whether the ECM motherboard includes anti-theft provisions.

The sensors and particularly those shown in FIG. 8, i.e., sensors 56 and 58 are typically at least partially mounted within the engine block 54 as is generally depicted in FIG. 9. By connecting the switch 80 to all or some of the sensors 56 through 74, the switch is therefore at least partially mounted in the engine block 54 and therefore presents significant difficulty for potential thieves to tamper with the arrangement. This is in marked contrast to the disposition of the ECM motherboard 82 which is easily accessible.

In this manner, the sensors 52 through 70 and the switch 80 (of which there may be several) can be integrated as a single unit. This arrangement is shown in FIG. 10 where the switch 80 and sensor 56 are unified as a single unit. FIG. 10 also shows in dashed line the possibility of augmenting security by linking various switches and sensors in tandem.

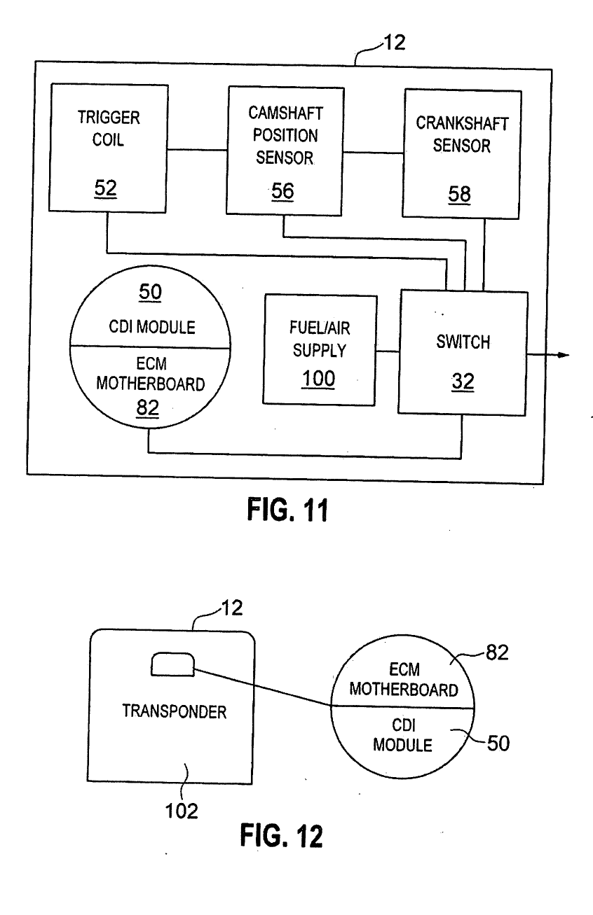

Referring now to FIG. 11, shown is a generic illustration which is applicable to either stator magneto arrangements or conventional internal combustion engines. Once again, it is illustrated the switch 32 is positioned within the housing 12 and that any one of the essential elements for engine operation such as the trigger coil 52 camshaft position sensor 56, crankshaft sensor 58, CDI module 50, ECM motherboard 82 and/or fuel/air supply 100 may be connected to the switch internally of housing 12 in order to provide the highest degree of security and therefore the lowest incidents of theft.

FIG. 12 illustrates a further variation of the arrangement when a transponder 102 is positioned within housing 12 and communicates with ECM motherboard 82 and CDI module 50.

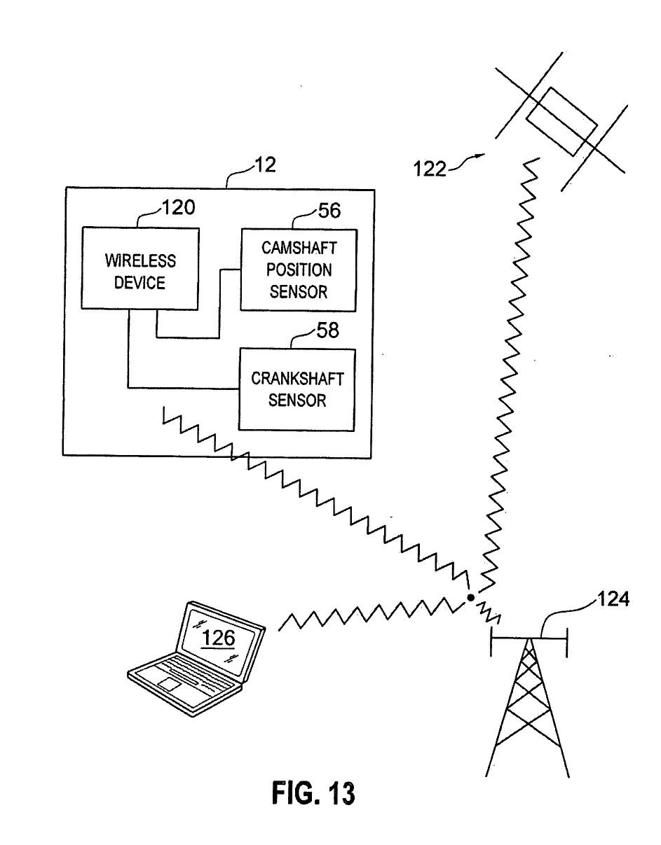

FIG. 13 illustrates yet another embodiment of the present invention in which a wireless transceiver is connected to the switch means for interrupting various operations of the vehicle. The interruption circuit has been discussed herein previously; however, in this embodiment the interrupt circuit includes a wireless communication means, such as a wireless transceiver or transponder. The overall union of these two elements is broadly denoted in FIG. 13 and represented by numeral 120. As referenced with respect to FIG. 9, the sensors 56 and 58 are in direct electrical communication with the interrupt circuit modified with the wireless transceiver.

By this arrangement, wireless communication is effected with the vehicle and in view of the fact that the interrupt circuit includes a wireless arrangement with sensors at least partially mounted within the engine housing 12, all of the advantages realized with respect to the difficulty in removal of the arrangement are immediately realized. This is not the case with existing wireless arrangements, such as, for example, the On Star™ system. The On Star™ system is very useful, however, it can be tampered with and even removed entirely from the engine compartment in view of the fact that the arrangement is not at least partially mounted within the engine housing. By incorporating the desirable features of the circuit discussed herein previously and augmenting the system with a wireless transceiver, all of the limitations of externally mounted wireless systems are overcome. As will be appreciated, this is particularly useful for tracking a stolen vehicle or, in extreme situations where the vehicle has been “chopped” the engine can be located by the wireless transponder.

In order to facilitate communication with the vehicle, the conventional system for wireless communications may be employed. This includes the satellites, one of which is shown in FIG. 13 denoted by numeral 122 which can communicate with a land based tower 124 for receiving and transmitting signals to the wireless arrangement 120 in engine housing 12 as well as a portable communication device 126, shown in the example as a laptop computer. It will be appreciated that other communication devices such as a web enabled cell phone, personal digital assistant or any other portable or permanent wireless communication device. This allows communication from land based systems such as the On Star™ with the tower and/or the individual circuit in the engine housing 12. This is useful to control engine functions such as specific engine operations, and is useful to perform diagnostics on the engine and convey this information to a user of the vehicle by way of a stereo system within the vehicle (both of which are not shown) or by other means such as a user's cellular phone (not shown).

It will also be appreciated that all of the functions that are presently available by wireless communication can be realized with the instant invention such as vehicle tracking, performance and other factors. It will be evident that any of the existing wireless networks can be employed with the system with the simple modification of a specifically tuned transponder/transceiver.

Although embodiments of the invention have been described above, it is not limited thereto and it will be apparent to those skilled in the art that numerous modifications form part of the present invention insofar as they do not depart from the spirit, nature and scope of the claimed and described invention.

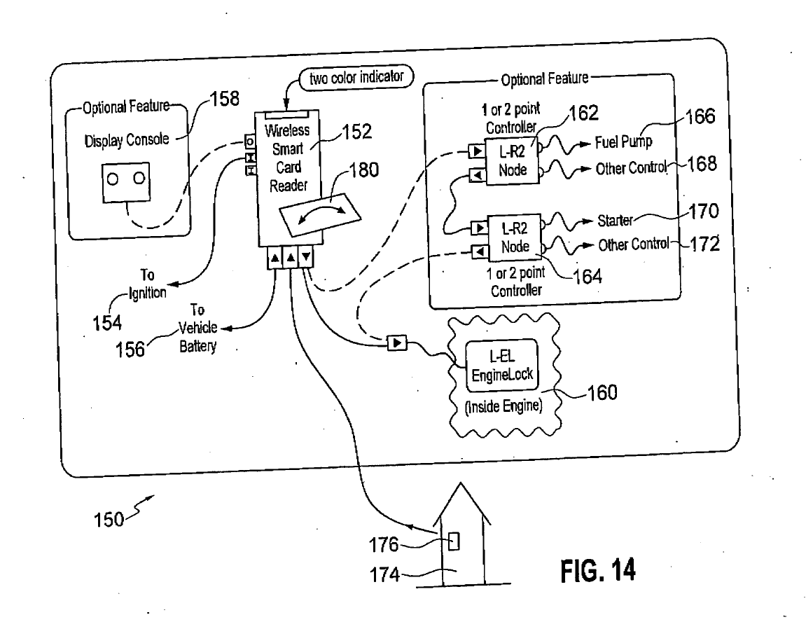

Turning to FIG. 14, numeral 150 is globally representative of a further system for use in the present invention. In the schematic illustration, a wireless smart card reader is denoted by numeral 152 which reader can be positioned within a vehicle (not shown) at any particularly convenient location. The card reader 152 is electrically linked to the ignition system of a vehicle (not shown) and globally denoted by numeral 154 as well as the vehicle battery (not shown) and globally denoted by numeral 156. In the embodiment shown, an optional feature is a display console 158 which could be directly connected to the wireless smart card reader 152.

As generally referenced herein previously, the wireless smart card reader 152 is electrically connected to the vehicle disabling circuit, globally referenced in the example by numeral 160. This disabling circuit 160 is the circuit that has been discussed extensively throughout the text herein supra. The vehicle disabling circuit 160 is one possible node; it is contemplated that other vehicle operating devices could be linked to the wireless card reader. This is referenced by the numerals 162 and 164. Numerals 162 and 164 are representative of modules that are linked to the wireless reader 152. These modules are effectively nodes which are connected to other vehicle functions. In the example, module 162 is indicated to be linked to the fuel pump 166 as well as another vehicle control device, referenced by numeral 168. In terms of module 164, the module could be linked to the vehicle starter motor denoted by numeral 170 as well as any other ancillary component to the starter motor or any other vehicle operating device, referenced by numeral 172 in the example. As a further example, the entire disabling circuit 160 may comprise a microprocessor with related supporting components and a semiconductor switch means.

It has been found that this system is particularly effective, namely the wireless system when combined with the vehicle disabling circuit discussed herein above. A particular advantage flows from the combination and it has been found that in the case of an emergency vehicle to augment the smart card technology with further access to a building is a particular benefit to avoid theft. In the illustration, numeral 174 is representative of a building structure having wireless transmission means 176 attached thereto. In this scenario, where the vehicle is a vehicle that requires constant engine running or is a vehicle where the engine must run and the driver(s) are preoccupied with an emergency situation or other urgent activity, the provision of the wireless access to the vehicle is particularly useful and this is augmented by the combination with a building. In the situation where an emergency were adjacent a hospital or a fire station or any related and authorized partner of such authorities, the use of the wireless means 176 from the building is effective to prevent unauthorized activity, namely theft, of the continuously running vehicle. With the combination of the driver or user having the wireless access, the vehicle is effectively always “disabled” until such time as the user or an authorized party (from a partner building) effects enablement of the vehicle.

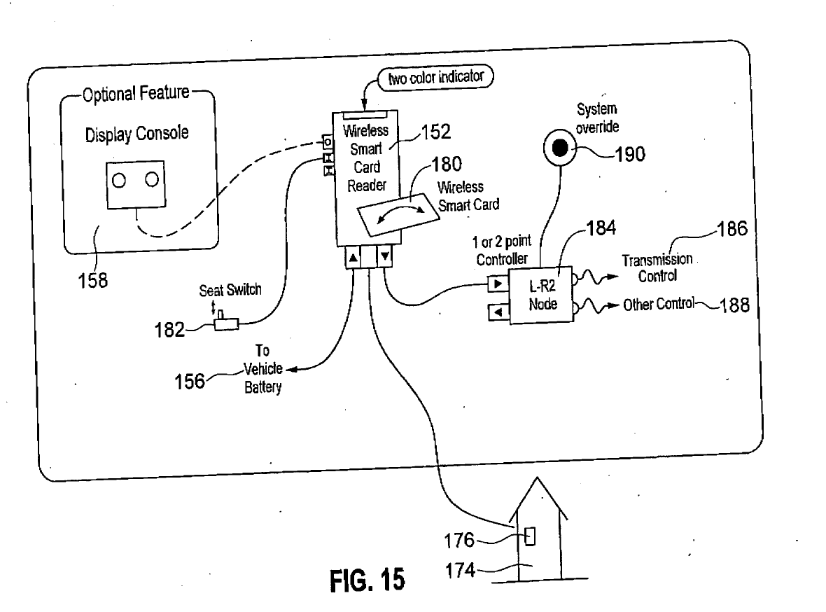

As a further benefit to the arrangement, use of the smart card in the instant arrangement, which card is globally represented by numeral 180 in each of FIGS. 14 and 15 can be a multi-function microprocessor card. Such cards are known to retain information from data received from other wireless devices. In the instant situation, such data could be from the group of kilometer use, fuel use, destination locations, elapsed time at location, individual accessing the vehicle, engine operating parameters (oil pressure, oil temperature, engine temperature), results of engine diagnostics, diagnostic modifications made wirelessly etc., materials received at a destination, building access and information relayed to the network of a destination building, vehicle enablement and/or disablement, inter alia.

It is contemplated that in order to incorporate such a system with existing vehicles, a bypass and databus interface would be required for inclusion within the circuit (not shown). This facilitates integration of the existing system with pre-existing original security equipment within the vehicle.

With specific reference to FIG. 15, shown as a further embodiment of the overall system illustrated in FIG. 14. In the latter embodiment, the system may include a switch 182, shown in the example as a seat switch. This system also includes a further node 184, which node can be linked to transmission control, denoted by numeral 186 or some other ancillary control denoted by numeral 188. As a further option the system may include an override device 190 to bypass the provisions of the system entirely. In the illustration, as an example when a vehicle is at the scene of an emergency, the engine, as noted previously, must be left running and the transmission is set appropriately to continue providing power for auxiliary demands. When the driver leaves the driver's seat of the vehicle (none of which is shown) the transmission is automatically locked. When the vehicle needs to be moved, the driver must sit in the driver's seat and place the smart card 180 within the vicinity of the reader 152. The user has the correct authority, the transmission will unlock and the vehicle will be available for use.

In terms of the override device 190, this could be installed in a location that will bypass the module or node 184 which is connected to the transmission. Further, the switch may have further contacts that can be used to notify the system that is has been overridden and this event will be logged. This information can be incorporated into the smart card as noted previously. When the system is disabled this can be indicated on the reader by an appropriate signal, i.e., an audible signal or a visual signal.

Although not shown, it is well within the purview of instant technology to provide a plurality of wireless cards 180 and a plurality wireless readers 152. The examples shown are representative and multiple levels of the system can be linked to accommodate a variety of vehicles and buildings.

The embodiment(s) of the invention described above is (are) intended to be exemplary only. The scope of the invention is therefore intended to be limited solely by the scope of the appended claims.

What is claimed is:

1. A system for preventing unauthorized use of a vehicle having an engine housing and means for enabling starting of said engine, comprising, in combination:
a wireless smart card reader;
a smart card for reading by said smart card reader;
a circuit for disabling operation of said vehicle operatively connected to said smart card reader, comprising:
an interrupt circuit electronically connected to said means for enabling starting of said vehicle, said circuit for selectively interrupting said means for enabling starting of said vehicle, said circuit being mounted directly within said engine housing;
switch means mounted within said engine housing and connected to said circuit for allowing interruption to said means for enabling starting of said vehicle, said switch means responsive to communication with said wireless smart card reader; and
battery connecting means for connecting said wireless smart card reader to the battery of a vehicle engine responsive to signals from said wireless smart card reader.

2. The system as set forth in claim 1, wherein said system further optionally includes ancillary modules connected to vehicle control devices and said wireless smart card reader.

3. The system as set forth in claim 2, wherein said vehicle control devices include a fuel pump.

4. The system as set forth in claim 2, wherein said vehicle control devices include the starter motor solenoid.

5. The system as set forth in claim 2, wherein said vehicle control devices include means for operation of the vehicle transmission.

6. The system as set forth in claim 2, wherein said system includes a plurality of said smart card readers.

7. The system as set forth in claim 1, wherein said system optionally includes override means for overriding said system.

8. The system as set forth in claim 1, wherein said system includes timer means for timing a period of recognition between said reader and said card.

9. The system as set forth in claim 1, wherein said card is a multifunction card.

10. The system as set forth in claim 9, wherein card is a multifunction microprocessor card.

11. The system as set forth in claim 10, wherein said multifunction microprocessor card retains information selected from the data group consisting of kilometre use, fuel use, destination locations, elapsed time at location, individual accessing said vehicle, engine operating parameters, materials received at a destination, building access and information relay to the network of the destination building.

12. The system as set forth in claim 1, further including a bypass and data bus interface for facilitating integration of said system with preexisting original vehicle security equipment.

13. A smart card based security system for preventing unauthorized use of a vehicle and unauthorized communication with a building, said system, comprising:
a vehicle wireless smart card reader connected within said vehicle;
a building wireless smart card reader for permitting communication with said building;
a smart card for communication with the readers;
a circuit for disabling operation of said vehicle operatively connected to said smart card reader, comprising:
an interrupt circuit electronically connected to said means for enabling starting of said vehicle, said circuit for selectively interrupting said means for enabling starting of said vehicle, said circuit being mounted directly within said engine housing;
switch means mounted within said engine housing and connected to said circuit for allowing interruption to said means for enabling starting of said vehicle, said switch means responsive to communication with at least one of said wireless smart card reader and said building wireless smart card reader; and
battery connecting means for connecting said wireless smart card reader to the battery of a vehicle engine responsive to signals from said wireless smart card reader, whereby said system is capable of data conveyance between said vehicle and said building.

14. The system as set forth in claim 13, wherein said system further includes ignition connecting means for connecting said wireless smart card reader to the ignition of a vehicle engine responsive to signals from said wireless smart card reader.

15. The system as set forth in claim 13, wherein said system optionally includes ancillary switch means for preventing unauthorized starting of said engine.

16. The system as set forth in claim 13, wherein said system further optionally includes ancillary modules connected to vehicle control devices and said wireless smart card reader.

17. The system as set forth in claim 16, wherein vehicle control devices include the fuel pump.

18. The system as set forth in claim 16, wherein said vehicle control devices include the starter motor solenoid.

19. The system as set forth in claim 16, wherein said vehicle control devices include means for operation of the vehicle transmission.

20. The system as set forth in claim 16, wherein said system includes a plurality of said smart card readers.

21. The system as set forth in claim 13, wherein said system optionally includes override means for overriding said system.

22. The system as set forth in claim 13, wherein said system includes timer means for timing a period of recognition between said reader and said card.

23. The system as set forth in claim 13, wherein said card is a multifunction card.

24. The system as set forth in claim 23, wherein card is a multifunction microprocessor card.

25. The system as set forth in claim 24, wherein said multifunction microprocessor card retains information selected from the data group consisting of kilometre use, fuel use, destination locations, elapsed time at location, individual accessing said vehicle, engine operating parameters, materials received at a destination, building access and information relay to the network of the destination building.

26. The system as set forth in claim 13, further including a bypass and data bus interface for facilitating integration of said system with pre-existing original vehicle security equipment.

27. A method for preventing unauthorized use of a vehicle having an engine housing and means for enabling starting of said engine, comprising:
providing said vehicle with a wireless smart card reader;
providing a smart card for reading by said smart card reader;
providing a circuit for disabling operation of said vehicle operatively connected to said smart card reader, comprising:
an interrupt circuit electronically connected to said means for enabling starting of said vehicle, said circuit for selectively interrupting said means for enabling starting of said vehicle, said circuit being mounted directly within said engine housing;
switch means mounted within said engine housing and connected to said circuit for allowing interruption to said means for enabling starting of said vehicle, said switch means responsive to communication with said wireless smart card reader; and
battery connecting means for connecting said wireless smart card reader to the battery of a vehicle engine responsive to signals from said wireless smart card reader; and
contacting said smart card in proximity with said switch means to effect an enabled start of said vehicle.

28. The method as set forth in claim 27, wherein said method optionally includes providing ancillary switch means for preventing unauthorized starting of said engine.

29. The method as set forth in claim 27, wherein said method optionally includes providing ancillary vehicle control devices.

30. The method as set forth in claim 27, wherein said method further optionally provides ancillary modules connected to vehicle control devices and said wireless smart card reader.

31. The method as set forth in claim 30, wherein said vehicle control devices include a fuel pump.

32. The method as set forth in claim 30, wherein said vehicle control devices include a starter motor solenoid.

33. The method as set forth in claim 30, wherein said vehicle control devices include means for operation of the vehicle transmission.

34. The method as set forth in claim 27, wherein said system includes a plurality of said smart card readers.

35. The method as set forth in claim 27, wherein said system optionally includes override means for overriding said system.

36. The method as set forth in claim 27, wherein said system includes timer means for timing a period of recognition between said reader and said card.

37. The method as set forth in claim 27, wherein said card is a multifunction card.

38. The method as set forth in claim 37, wherein card is a multifunction microprocessor card.

39. The method as set forth in claim 38, wherein said multifunction microprocessor card retains information selected from the data group consisting of kilometre use, fuel use, destination locations, elapsed time at location, individual accessing said vehicle, engine operating parameters, materials received at a destination, building access and information relay to the network of the destination building.

40. The method as set forth in claim 27, further including a bypass and data bus interface for facilitating integration of said system with pre-existing original vehicle security equipment.

41. A method for preventing unauthorized use of a vehicle and unauthorized communication with a building based on a smart card platform security system, comprising:
providing a vehicle wireless smart card reader connected within said vehicle;
providing a building wireless smart card reader for permitting communication with said building;
a smart card for communication with the readers;
providing a circuit for disabling operation of said vehicle operatively connected to said smart card reader, comprising:
an interrupt circuit electronically connected to said means for enabling starting of said vehicle, said circuit for selectively interrupting said means for enabling starting of said vehicle, said circuit being mounted directly within said engine housing;
switch means mounted within said engine housing and connected to said circuit for allowing interruption to said means for enabling starting of said vehicle, said switch means responsive to communication with at least one of said wireless smart card reader and said building wireless smart card reader; and
battery connecting means for connecting said wireless smart card reader to the battery of a vehicle engine responsive to signals from said wireless smart card reader, whereby said data conveyance between a vehicle point and a building point, a user point and said vehicle point, said user point and said building point and said vehicle point and said building point is effected wirelessly through said readers and said card to prevent illegitimate activity through the points.

42. The method as set forth in claim 41, wherein said method optionally provides ancillary switch means for preventing unauthorized starting of said engine.

43. The method as set forth in claim 41, wherein said method further optionally provides ancillary modules connected to vehicle control devices and said wireless smart card reader.

44. The method as set forth in claim 41, wherein said vehicle control devices include the fuel pump.

45. The method as set forth in claim 41, wherein said vehicle control devices include the starter motor solenoid.

46. The method as set forth in claim 41, wherein said vehicle control devices include means for operation of the vehicle transmission.

47. The method as set forth in claim 41, wherein said method includes providing a plurality of said smart card readers.

48. The method as set forth in claim 41, wherein said method optionally includes override means for overriding said system.

49. The method as set forth in claim 41, wherein said system includes timer means for timing a period of recognition between said reader and said card.

50. The method as set forth in claim 41, wherein said card is a multifunction card.

51. The method as set forth in claim 50, wherein card is a multifunction microprocessor card.

52. The method as set forth in claim 51, wherein said multifunction microprocessor card retains information selected from the data group consisting of kilometre use, fuel use, destination locations, elapsed time at location, individual accessing said vehicle, engine operating parameters, materials received at a destination, building access and information relay to the network of the destination building.

53. The method as set forth in claim 52, further including providing a bypass and data bus interface for facilitating integration of said system with pre-existing original vehicle security equipment.

54. A method for controlling vehicle function, operation and unauthorized use of said vehicle having an engine and block therefor, sensors for effecting engine activation and other functions, a power source, ignition coils, and means for establishing communication between said sensor and said coils, said method comprising the steps of:
providing switch means for and augmenting communication to and/or from said sensors for altering function of said sensors;
providing wireless transceiver means connected to said switch means for receiving electromagnetic signals from a signal service provider and transmitting electromagnetic signals to said signal service provider, said switch means being actuable by said transceiver means;
positioning said switch means and said transceiver means between at least one sensor of said sensors and said means for establishing communication between said sensors and said coils;
mounting said switch means and said transceiver means to said at least one sensor; and
activating said switch means by said transceiver means for communicating with said sensors for altering engine activation and other functions.

55. The method as set forth in claim 54, wherein said transceiver means comprises a satellite communication device.

56. The method as set forth in claim 54, wherein said transceiver means comprises a cellular phone unit.

57. The method as set forth in claim 54, wherein said transceiver means comprises a radio frequency transceiver.

58. The method as set forth in claim 54, wherein said transceiver means comprises a combination of radio frequency transceiver, satellite communication device and a cellular phone unit.

59. The method as set forth in claim 54, wherein said sensors are mounted at least partially in said block of said engine.

60. The method as set forth in claim 54, wherein said switch means is mounted directly to said at least one sensor.

61. The method as set forth in claim 54, wherein said switch means and said transceiver means is positioned within said engine block.

62. The method as set forth in claim 54, wherein said sensors are positioned within said engine block.

63. An arrangement for controlling vehicle function, operation and unauthorized use, said vehicle having an engine and block therefor, sensors for effecting engine activation and other functions, a power source, ignition coils, and means for establishing communication between said sensor and said coils, said arrangement comprising the steps of:
switch means for communication with said sensors for altering functioning of said sensors;
wireless transceiver means connected to said switch means for receiving electromagnetic signals from a signal service provider and transmitting electromagnetic signals to said signal service provider, said switch means being actuable by said transceiver means; and
said switch means and said transceiver means located between at least one sensor of said sensors and said means for establishing communication between said sensors and said coils, whereby upon activation of said switch means by said transceiver means said sensors alter engine activation or other selected functions.
